(19) United States
(12) Patent Application Publication
(10) Pub. No.: US 2014/0195412 A1
(43) Pub. Date: Jul. 10, 2014

(54) INCREASED EFFICIENCY FOR UNDERWRITING LOANS

(71) Applicants: Michael Sidney METZ, Phoenix, AZ (US); David Clark DEATRICH, Scottsdale, AZ (US); Michael Joseph SULLIVAN, Scottsdale, AZ (US)

(72) Inventors: Michael Sidney METZ, Phoenix, AZ (US); David Clark DEATRICH, Scottsdale, AZ (US); Michael Joseph SULLIVAN, Scottsdale, AZ (US)

(21) Appl. No.: 13/734,123

(22) Filed: Jan. 4, 2013

(51) Int. Cl. G06Q 40/02

(52) U.S. Cl. CPC G06Q 40/025
USPC 705/38; 705/4

(57) ABSTRACT

Exemplary method, system, and computer program product embodiments for increased efficiency for underwriting are provided. In one embodiment, by way of example only, collected data obtained from dynamic sections in a web portal is processed, thereby instantaneously underwriting at least one of an available multiplicity of financial products via a decision engine without necessitating the forwarding of the collected data to an external underwriting system. Additional system and computer program product embodiments are disclosed and provide related advantages.

### BACKGROUND OF THE INVENTION

1. Field of the Invention

The present invention relates generally to computers, and more particularly, to mechanisms for increasing efficiency in underwriting in a computing environment.

2. Description of the Related Art

In today's society, there are a significant amount of underwriting businesses for loans and insurance policies. Also, there are a variety of types financial vehicles, such as loans and insurance policies, which are underwritten based at least partly upon, for example, the loan or insurance policy being requested. The process of applying for a loan, such as a mortgage and/or insurance policy can be costly and time consuming. Adding to the existing complexity, various underwriters of the loan and/or insurance policy may require different criteria for processing and underwriting.

### SUMMARY OF THE DESCRIBED EMBODIMENTS

Finance, including such industries as consumer and commercial lending, insurance and similar businesses, generates billions of dollars each year for the services they provide. Often due to the volume of loan types, securities, and insurance claims and policies processed by banks and insurance companies, several underwriters may be necessary. Requiring a human underwriter to analyze every application received by a company lengthens the application processing time. Applicants applying for loans and/or insurance policies may have to wait to a long time for low risk applicants to be approved for loans and/or insurance policies due to the number of applications received by a human underwriter. In addition, utilizing several different underwriters may cause inconsistencies on which policies and/or claims are accepted. Each underwriter may use different rules to determine whether to accept a particular loan and/or insurance claim for underwriting a desired policy. Some underwriters may even “cheat” the numbers so as to ensure that a particular applicant qualifies for a certain product. Even when underwriters implement a similar set of rules, inconsistencies may arise as each underwriter applies the rules in a different manner. As a result, a need exists for an automated and more standardized process of underwriting financial vehicles, such as loans and insurance policies.

Accordingly, and in view of the foregoing, various method, system, and computer program product embodiments for increased efficiency for underwriting are provided. In one embodiment, by way of example only, collected data obtained from dynamic sections in a web portal is processed, thereby instantaneously underwriting at least one of an available multiplicity of financial products via a decision engine without necessitating the forwarding of the collected data to an external underwriting system. Additional system and computer program product embodiments are disclosed and provide related advantages.

The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 illustrates an exemplary computing system in which aspects of the present invention may be realized;

FIG. 2 illustrates an exemplary computing system in which aspects of the present invention may be realized;

FIG. 3 is a flowchart illustrating an exemplary method for increased efficiency for underwriting;

FIG. 4 is a flowchart illustrating an additional exemplary method for increased efficiency for underwriting; and

FIG. 5 is a flowchart illustrating an additional exemplary method for increased efficiency for underwriting using product parameters in the decision engine.

### DETAILED DESCRIPTION OF CERTAIN EMBODIMENTS

Underwriting refers to a process that a financial institution service provider (e.g., bank, insurer, investment house, etc.) uses to assess the eligibility of a customer to receive the financial institution service provider's products (e.g., equity capital, insurance, mortgage, securities and/or credit). In accordance with the present invention, a borrower may obtain a loan and/or insurance policy for one of several different types of loans and/or insurance policies provided by various financial institutions, private lenders, and/or other sources recognized within the industry and instantaneously underwrite the lean and/or insurance policy. As will be described below, the present invention relates to moving beyond both the pre-approval/pre-qualification and the full approval for underwriting of an online applicant and actually instantaneously perform the underwriting for one of the approved loans and/or insurance policies at the time the applicants applies for the loan and/or insurance policy without necessitating the forwarding of the collected data to underwriting systems. It should be noted that the definitions described herein are applicable to the illustrated embodiments by way of example, and other definitions, as commonly understood in the art, may be applicable as well for describing the functionality and purpose of the illustrated embodiments of the present invention.

In one embodiment, by way of example only, collected data obtained from dynamic sections in a web portal is processed, thereby instantaneously underwriting at least one of an available multiplicity of financial products via a decision engine without necessitating the forwarding of the collected data to an external underwriting system. In one embodiment, the financial products may include a wide array of financial vehicles that are provided to an applicant, such as a commercial loan, a consumer loan, a home mortgage, a vehicle loan, property insurance, vehicle insurance, commercial insurance, employment insurance, health insurance, or other types of loans and insurance and the like.

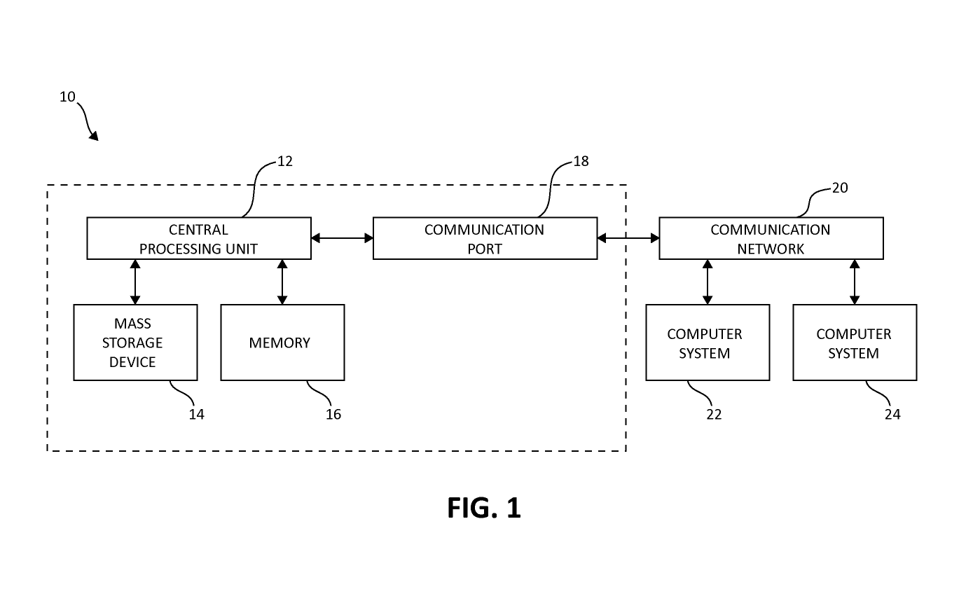

Turning to FIG. 1, an exemplary computing system 10 is depicted in which aspects of the present invention may be realized. Computer system 10 includes central processing unit (CPU) 12, which is connected to mass storage device(s) 14 and memory device 16. Mass storage devices may include hard disk drive (HDD) devices, which may be configured in a redundant array of independent disks (RAID). Memory device 16 may include such memory as electrically erasable programmable read only memory (EEPROM) or a host of related devices. Memory device 16 and mass storage device 14 are connected to CPU 12 via a signal-bearing medium. In addition, CPU 12 is connected through communication port 18 to a communication network 20, having an attached plurality of additional computer systems 22 and 24. The computer system 10 may include one or more processor devices (e.g., CPU 12) and additional memory devices 16 for each individual component of the computer system 10.

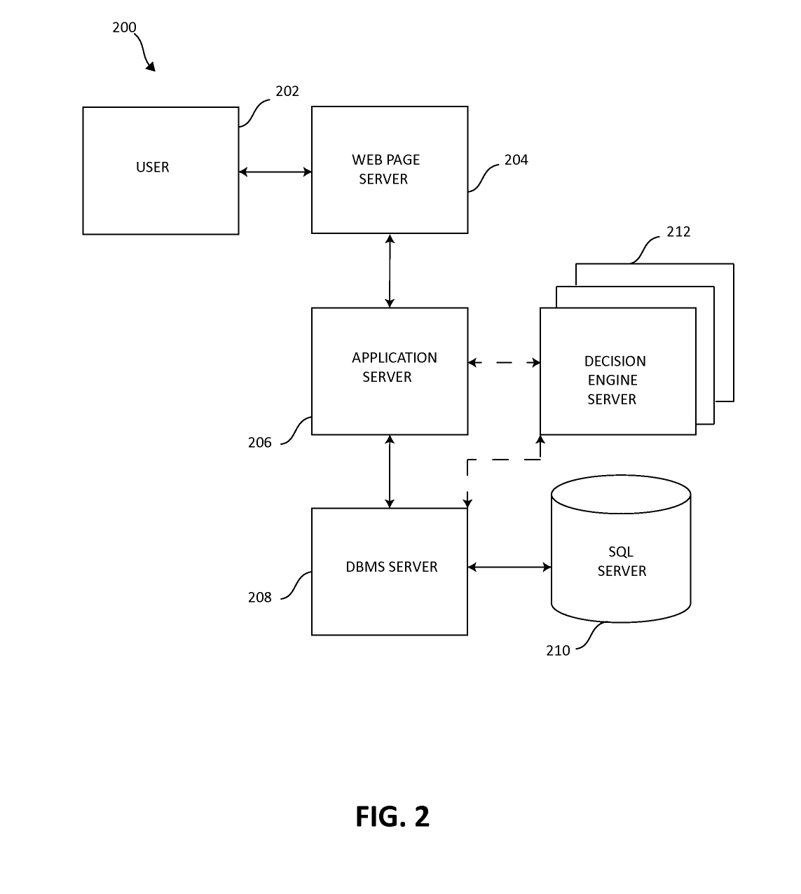

FIG. 2 is an exemplary computing system 200 in which aspects of the present invention may be realized. In one embodiment, by way of example only, a user 202 (e.g. an applicant) is in communication with a web page server 204. The web page server 204 may either be hardware or software based and assists to deliver content that may be accessed over the Internet to the user 202. A bi-directional flow of data may be passed to and from each component. The application server 206 may be either a hardware and/or software framework for creating an application-server implementation. The application server 206 may be implemented for the efficient execution of procedures (e.g., programs, routines, scripts, etc.) for supporting the applied applications. The application server 206 may be in direct communication with both a database management system (DBMS) server and a decision engine server 212. The DBMS server may also be hardware and/or software based and assists to control the creation, maintenance, and the use of a database. The DBMS may be an integrated collection of data records, files, and other objects. The DBMS allows for different user application programs to concurrently access a database. A variety of database modules (e.g., relational model or object model) may be used to conveniently describe and support an application. Various query languages, as commonly used in the art, may be supported. The DBMS may be adapted for controlling data access, enforcing data integrity, managing concurrency control, recovering a database after failures, and restoring a database form backup files, as well as maintaining database securities. The DBMS may also be adapted to perform any additional functions as commonly known and applied in the art.

A structured query language SQL database 210 is also in communication with the DBMS server 208. The SQL database 210 may be a relational database whose primary function is to store and retrieve data as requested by a software application, whether the SQL database 210 is on the same computer or those software applications running on other computers communicating across a network (including the internet). The decision engine server 212 (e.g., a decision engine), being in communication with the DBMS server 208, may be adapted for processing the collected data for instantaneously underwriting loans without necessitating the forwarding of the collected data to underwriting systems. One or more decisions engines 212 may be implemented to execute the present invention, as described throughout the description.

Within the web page server 204, a web page and web portal may be presented to the user 202. By way of example only, the web page may consist of a home page, a loan/insurance education page, a section about the loan/insurance policies available, a web portal containing dynamic sections as will be described below, a section for providing documentation to the borrower, and an exit strategy (e.g., a “what's next section”).

Within the education page, the web site may provide information about the loan/insurance approval and underwriting process, a “what's next section” subsection, definitions of the various documents, and the type of products for the loans/insurance policies. A mission statement and vision may be provided within the section discussing the loan/insurance. The mortgage portal provides a series of questions used to gain answers from the user 202 to make a decision via the decision engine 212 on qualification. In one embodiment, the web page for the web portal may consist of an ASP.net front end with C# code to manipulate the data with the SQL database 210 to store the information obtained from a user 202. Each of the dynamic sections of the web portal may be satisfied in any order. When the questions are provided for each of the dynamic sections, the dynamic sections may be cleared. The user will be notified when each section is completed and/or if additional information is required for a particular dynamic section. As the user 202 inputs data, the dynamic sections may change for presenting questions based upon the answers provided by the user 202. As such, the types of loans/insurance polices available at the time of the application are presented to the user 202 based upon the collected data from the user via the web page.

In one embodiment, by way of example only, consider the following scenario where a user is seeking a mortgage loan. The mechanisms of the illustrated embodiments present a dynamic web page in the web page server 204 to the user 202 for gathering information in response to questions presented. The web page also gathers information from the SQL database 210. The webpage presents questions for the user 202 to either manually enter information (e.g., the user enters income amounts or an estimated amount for a home or commercial property for which the user 202 is seeking a loan and/or insurance) and/or select one of several answers automatically provided with the questions. Next, the data obtained from the web page/portal of the web page server 204 and manipulated by the application server 206, will be stored in the SQL database 210. Also, any questions (and answers) contained in each of the dynamic sections of the web portal along with the rates, terms and conditions, and various factors of each underwriter will be stored in the SQL database 210.

The data that is collected from the user 202 by the web page server 204 is fed into the application server 206. Here the application server 206 performs a variety of services for processing the data. For example, the application server 206 reads/writes a housing code to the SQL database and the information is passed to the DBMS server 208. The housing code and the collected data are manipulated by at least one of the decision engine servers 212 for the mortgage loan application. All housing forms required for a mortgage application package will be automatically generated with the manipulated data. One or more of the decision engine servers 212 will process the manipulated data, determine the approval of the mortgage loan application, and perform the underwriting of the mortgage loan containing all of the terms and conditions, including the rates, based upon the collected data of the user and the terms and conditions for the type of loan required by the financial institution. It should be noted that a variety of different loan types may be considered. Both the decision to approve and the actual underwriting process is based upon the available types of mortgage loans at the time the user enters the information and also upon the mortgage loan type that best matches the application with the appropriate financial institution. For example, if the dynamic sections indicate the user 202 presents a high risk, the decision engine 212 will analyze the various types of financial lenders currently offering services to high risk customers and then match the user's 202 information with the financial lenders that most closely matches the risks, terms, conditions, predetermined qualifications, and/or other information required by the financial lender for underwriting the loan and/or insurance (e.g., the decision engine 212 matches the users 202 information with each of the financial lenders factors for underwriting the loan, such as credit, cash flow, capacity, and/or collateral of the user).

This process allows for instantaneously underwriting a mortgage loan (and/or insurance policy) for multiple underwriting systems, providing all necessary documentation, and guaranteeing and funding the loan (and/or insurance policy) online. In this way, financial, as well as insurance, institutions are bypassed, and the need for forwarding the mortgage/insurance approval application to one of several underwriting systems (e.g., mortgage and insurance underwriters), and then receiving a decision from one of the underwriting systems, is eliminated in short, the underwriting is performed “in-house.” In addition, the website presents to the user a packet at the end of the process that contains all the information for the financial institution to originate the loan. The packet will include all federal and state regulations required by law for the particular type of loan (and/or insurance in the event the user 202 is applying for a loan). Also, the packet may include the decision for approving the loan, all the terms and conditions for the user and the financial institutions to fulfill, and the underwriting documentation containing all the terms and conditions, including the rates. Also, it should be noted that the user 202 may request the decision engine 212 reprocess the application for underwriting the loan/insurance policy if the user 202 is unsatisfied with the best matching underwriting system. The users 202 may be informed, by the decision engine 202 at any time, of the best matching financial/insurance institution. For example, the user 202 may be informed by the decision engine 202 at the time of the matching, but previous to the underwriting, of the best matching financial institution. Upon conclusion of the underwriting for the best matching financial institution, the next best financial institution may be selected for the user 202 by the decision engine 212, and then perform a subsequent underwriting operation. Such processes may repeat as many times as necessary until the user 202 is satisfied. As mentioned previously, the example provided may also be applied for underwriting various types of insurance policies with the appropriate required documentation, regulations, terms and conditions, rates, and other information relating to underwriting insurance appropriately included for manipulating the collected data, approving the application, and instaneously underwriting the insurance policy while bypassing insurance agent(s), insurance brokers and eliminating the need for forwarding the insurance policy approval application to one of several underwriting systems.

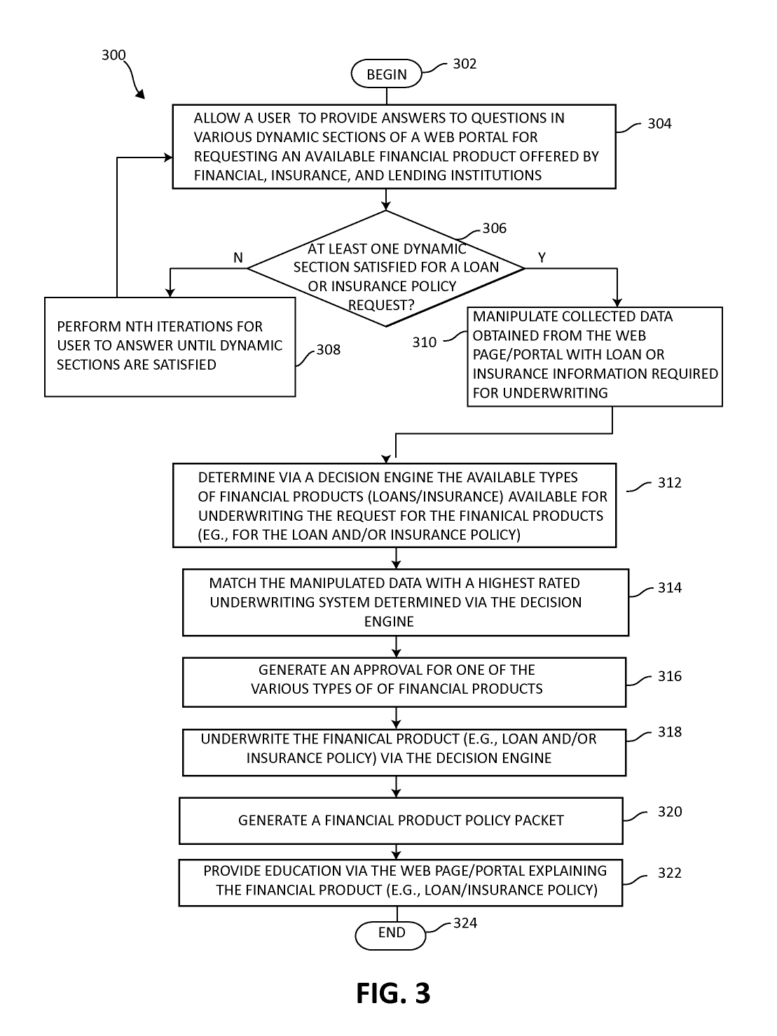

FIG. 3 is a flowchart illustrating an exemplary method 300 for increased efficiency for underwriting. The method 300 begins (step 302). The method 300 allows a user (e.g., a single individual or corporation, etc.) to provide answer to questions in various dynamic sections of a web portal for requesting one of variety types of financial products (e.g., loans/insurance policies) offered by one or more financial institutions, public/private investment institutions, insurance underwriters, and/or lending services and the like (step 304). The process to gather the information from the borrower may be performed through the web portal. For example, the web portal may have at least 11 sections. These sections may include the following dynamic sections (see list below), which may be presented automatically with multiple-choice answers presented and/or in a question/answer type option for the user to manual input the required data. Each of these sections may be dynamic, meaning, depending upon the answer to each of the questions/required responses listed below in outline form, more questions may be asked of the user by the web portal to receive additional information to satisfy the needed information for the particular section.

### Dynamic Section 1—Borrower Information

a. Borrower
   i. Name
   ii. Social Security Number
   iii. Date of Birth
   iv. Home Phone
   v. Total number of years in school
   vi. Marital Status
   vii. Number of Dependents (including the ages)
   viii. Declaration of citizenship
   ix. Declaration of Permanent Resident Alien
b. Co-Borrower information
c. Co-Applicant

### Dynamic Section 2—Type of Loan/Insurance

a. Loan/Insurance purpose
   i. Purchase
      1. Down Payment
         a. Source of down payment (e.g., is there any part of the down payment being borrowed?—Declaration made by the applicant
   ii. Rate and Terms
      1. Year acquired
      2. Amount of any existing liens
   iii. Cash-Out
      1. Amount of cashout
      2. Reason for a cashout
b. Occupancy
   a. Will the property be owner occupied
   b. Is this a second home
   c. Will this be an investment property
   d. Declaration of the intent to occupy

### Dynamic Section 3—Property Information

a. What is the property address
   a. Street name
   b. Unit Number
   c. City
   d. State
   e. Zip code
b. Type of property
   i. Single Family residence, condo, townhome, commercial, etc.
a. Yeah the building was built
b. Names on the title
ii. Legal description
   1. Estate
   2. Is it fee simple
      Dynamic Section 4—Residency History (Count the number of residences)
a. What is the current address of the borrower
   i. Does the owner rent/own
   ii. What is the length of time of owning/renting
   iii. What is the mailing address
   iv. Is the mailing address different
b. Previous Addresses
   i. Provide 3 full years of residency history
c. Obtain a declaration by the user of any previous home/commercial property ownership
   i. Type
   ii. Principal
   iii. Second home
   iv. Investment
   v. How was the title held
      i. Self?
      ii. Joint-Spouse?
      iii. Joint-other person?

### Dynamic Section 5—Employment History

a. Current Employment
   i. Self-Employed
   ii. Wage Earner (provide W2 information if necessary)
b. Previous Employers
   i. Names
   ii. Addresses
   iii. Dates Employed
   iv. Positions/Title
   v. Phone #s
   vi. The amount of time in line of work

### Dynamic Section 6—Income

a. Current Employment Income
   i. Amount
b. Retirement/Pension Income
c. Rental Income
d. Other Income

### Dynamic Section 7—Credit

a. Credit Score
b. Credit History
   i. Declaration of Judgments
   ii. Declaration of Bankruptcy
   iii. Declaration of Foreclosure
   iv. Declaration of Lawsuit
   v. Declaration of Obligated
   vi. Declaration of Federal/State Debt

### Dynamic Section 8—Expenses

a. Housing Expenses
   i. Current housing/commercial rental expenses
      1. Principal
      2. Interest
      3. Taxes
      4. Insurance
      5. Rent
      6. H.O.A. Fee/Common, area, and Maintenance fee that are due
      7. Second Mortgage/loan Payment
   ii. Other real estate
      1. Same as current housing/commercial property
      2. Provide addresses
b. Credit Cards
c. Loans
   i. Student Loans
   ii. Auto Loans
   iii. Co-signer
   iv. Lines of Credit
   v. Payroll deductions
   vi. Declaration of Endorser on any notes (e.g., a promissory note)
d. Alimony and Child Support
   i. Spousal maintenance
   ii. Declaration of child support

### Dynamic Section 9—Assets

a. Bank Accounts
b. Stocks Bonds
c. Retirement Assets
d. Real Estate Owned
e. Certificates of Deposit
f. Other
   i. Life insurance

### Dynamic Section 10—Loan Details

a. Type of Mortgage
   i. FHA, VA, and/or Conventional
b. Loan Amount
c. Interest Rate
d. Loan Term
e. Amortization
f. Names to be listed on the loan
i. How will the title be held

### Dynamic Section 11—Type of Insurance and Details

a. Type of Mortgage
   i. Real Estate, Life, property & casualty, health, Malpractice, Employment, Automobile, credit, all-risk types, Workers Compensation, Sports, Benefits, Employment Securities, etc.
b. Policy Amounts/Limits
c. Interest Rate
d. Premiums
e. Amortization
f. Coverage types
g. Risk acceptance level
h. Declaration of any prior insurance claims
i. Declaration of any prior lawsuits against any insurance company
h. Declaration of any preexisting conditions based upon the type of insurance

It should be noted that the list provided is not to be construed as limiting, but provides the type of information that may be collected via the web portal. These dynamic sections are configurable and additional sections may be added with any additional questions and/or requests for information/declarations to be required of the user. Each section and/or subsection may be added to as various regulations, either internationally and/or nationally, changes. Also, the various underwriting institutions approving and underwriting the loan/insurance policy may provide additional information to be obtained and required from the user that is not currently listed below. In short, this list is not to be construed as an exhaustive list, but is provided as an example to illustrate the dynamic sections.

Continuing on with method 300, a determination is made to see if at least one of the dynamic sections is satisfied for the financial produce (e.g. loan/insurance) type requested (step 306). If no, the method 300 may perform nth iterations of questions for user to answer until dynamic section(s) are satisfied (step 308). If yes, the collected data obtained from the web page/portal is manipulated with financial product (e.g., loan/insurance) information required for underwriting (step 310). The method 300 may determine via a decision engine the available types of financial products (e.g, loans/insurance policies) (step 312). The method 300 may match the manipulated data with the highest rated underwriting system via the decision engine (step 314). This rating system may be based upon multiple factors, including but not limited to credit, cash flow, loan/insurance history, collateral, rates, etc., and a point system may be applied to the factors and each sub factor. The rating system may take an average of the combined total of numbers and determine a rating for the multiple lender/insurance policy underwriters. A decision engine may at anytime inform the user via the web portal of the matching underwriters with the appropriate ranking that is generated. Upon completing the matching, the method 300 may generate an approval for one of the various types of financial products (step 316). At this point, the financial institutions and/or underwriting systems are bypassed and the need to forward the approval decision to the underwriting systems and financial institutions is eliminated.

It should be noted that, in conjunction with the underwriting, a decision is generated for an approval for at least one of the financial products via the decision engine. In one embodiment, the decision may be a “soft” approval. This soft approval may be an approval for one of the financial products based upon an agreement made between a financial product provider and a retailer, 3^{rd} party representative, seller, or provider of the financial products of the financial institution who is authorized to use and administer, to applicants of the financial providers, the embodiments of the present invention described herein. For example, one or more financial institutions may enter into an agreement with a mortgage broker, which uses the present invention described herein, to approve all applicants who qualify and have successfully received a loan underwritten by the decision engine. In this way, the one or more financial institutions may successfully approve applicants having the underwritten loan. In one embodiment, the soft approval may be a generic and/or a first approval for the underwritten loan subject to additional scrutiny or internal review by the financial services provider that is external to the present invention system. In one embodiment, the processing occurs in the web portal and the decision is forwarded to the external financial services provider so all and/or at least a majority of the underwriting occurs via the decision engine. The decision may also be defined according to one or more financial institution standards, policies, definitions, and/or requirements. The decision may also be defined according to each provider of the present invention's standards, policies, definitions, and/or requirements. Also, the decision may also be defined according to government standards, policies, definitions, and/or requirements.

As mentioned previously, the decision engine may be configured for informing the user of the best matching underwriting institution. The user may then elect to proceed with the best matching underwriting system and/or request the decision engine to continue with the next highest matching financial/insurance underwriting system offering the loan/insurance policy. This process may continue nth integrations until the user is satisfied. Once the best matching underwriting system is determined, the method 300 will subsequently underwrite the loan/insurance via the decision engine (e.g., the decision engine underwrites the loan/insurance policy “in-house”) (step 318). The method 300 will then generate a loan/insurance policy packet (step 320). The packet provides the user of terms and conditions, rates, any governmental required documents (e.g., federal and state documentations), the approval decision, educational material explaining the underwriting and terms, conditions, rates, and/or any other required documentation for the loan/insurance policy. The packet may be printed and/or electronically delivered to the appropriate financial lender/insurance company underwriting the loan/insurance policy. Also, after completing the packet, a “what's next” section is provided to the user via the web portal. This section may also provide similar and/or additional educational material relating to the loan/insurance policy, the loan/insurance process and any documentation that may be needed to satisfy the underwriting conditions via the web portal (step 322). The method 300 may end (step 328).

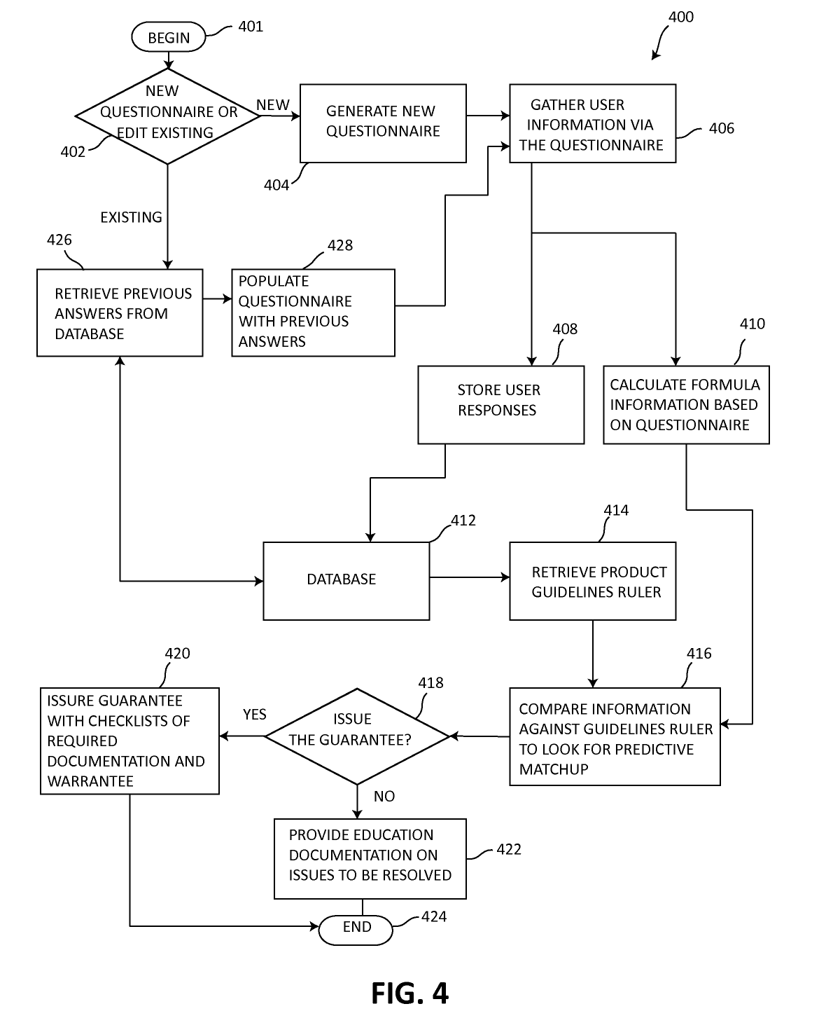

In one embodiment, by way of example only, as described below in FIG. 4, the system of the present invention begins by calculating whether the user started an application earlier. Certain application data is saved securely in the system for later reference, if opted by the user. If any previous data was saved, this is retrieved. The user's information is gathered by a dynamic questionnaire, in which responses to the questions are saved in the system and analyzed for further questioning as required by the decision engine. The borrower is notified immediately regarding any red flags that pop up that would cause loan denial. Once adequate information is gathered to make a decision, the saved database containing the borrower's information is referenced to run relevant calculations and compare against product guidelines. A decision and guarantee is offered, or an explanation is provided as to why no guarantee may be provided. In other words, the loan application is immediately approved, underwritten, and/or an explanation provided as to the reasons for declination of the application. The borrower is also provided customized educational documentation that references the user's saved answers.

FIG. 4 is a flowchart illustrating an additional exemplary method 400 for increased efficiency for underwriting. The method 400 begins (step 401) by determining if a questionnaire is a new questionnaire or if the questionnaire is an existing questionnaire that is being edited (step 402). If the method 400 is requiring a new questionnaire, a new questionnaire is generated (step 404). This includes a blank questionnaire to be provided for gathering information from the applicant/user. The method 400 gathers the user's information via the questionnaire (step 406). Upon conclusion of gathering the user's information, the method 400 both stores the user's responses (step 408) and calculates formula information based upon the answers to the questions provided to the users in the questionnaire (step 410). The stored responses from step 408 are then sent as new responses to a database (step 412). A product guideline's ruler is sent from the databases and retrieved (step 414). The method 400 then combines the product guideline's ruler and the formula results and compares the information (e.g., the formula results) against the product guideline's ruler to look for a predictive matchup (step 416). The method 400 then determines if a guarantee could be issued (step 418). If yes, the guarantee is issued with a checklist of required documentation and a warrantee (step 420). The guarantee may in one embodiment include both an approval of the loan/insurance application and simultaneously underwrite the loan/insurance policy. This step eliminates the need for sending the approved application to an underwriter to be underwritten. If not, the method 400 provides educational documentation on issues needing to be resolved (e.g., teachings relating to how to receive a guarantee) (step 422). Returning to step 402, if the questionnaire is an existing questionnaire, the method 400 retrieves the previous answers from the database (step 426). The method then populates the questionnaire with the previous answers retrieved from the database (step 428). The method 400 then continuous on to step 406 and continues. The method 400 ends (step 424).

In one embodiment, depending upon the gathered information from the applicant/user and depending upon the answer to each of the questions/required responses, as discussed above in FIG. 3 and FIG. 4, product parameters may be used in the decision engine. The product parameters are rules that may be programmed and linked to specific products based on the captured data from the applicant/user. For example, when a lender, loan officer, insurance agent, and the like find a new product, these new products may be entered into the decision engine and the sample parameters may be programmed for the new products. Below are a list of various product parameters that may be programmed in the present invention and may be used by the decision engine combined with the product guideline's ruler and the formula results and compares the information (e.g., the formula results) against the product guideline's ruler to look for a predictive matchup:

### Sample Product Parameters:

1. List of product name (e.g., FHA, VA, USDA, Conventional, HARP, DU Refi Plus, High Balance, Jumbo, 97 Flex, LP Open Access, Hard Money

### 2. Purchase, Rate/Term, Cash Out

### 3. Fixed, ARM, Interest Only, ARM Caps, Margins

### 4. SFR, 2 Unit, 3-4 Unit, Condo

### 5. LTV/CLTV

6. >80% LTV conventional, MI % Coverage, MI Factor
7. FHA and VA MI only rule, Upfront premium, Monthly premium
8. USDA only rule, Residual income

### 9. Waiving Escrows

10. Investor pricing on different rates
11. Investor SRP's based on same factors
12. Loan amount
13. Term—10, 15, 30 year fixed
14. P&I calculations based off of all factors

### 15. Fico Score

16. Owner occupied, 2nd home, Investment property
17. Temporary buydowns
18. Locking a loan
19, 30, 45 day
20. Down payment
21. List of products: e.g., FHA, VA, USDA, Conventional, HARP, DU Refi Plus, High Balance, Jumbo, 97 Flex, Open Access, Hard Money
22. State adjustments or restrictions
23. Escrow holdbacks
24. Identity of interest

### 25. Gift of Equity

26. Gift funds
27. Rapid acquisition
28. Non-arm's length transaction
29. Down payment assistance
30. Debt to income ratios and front and back end

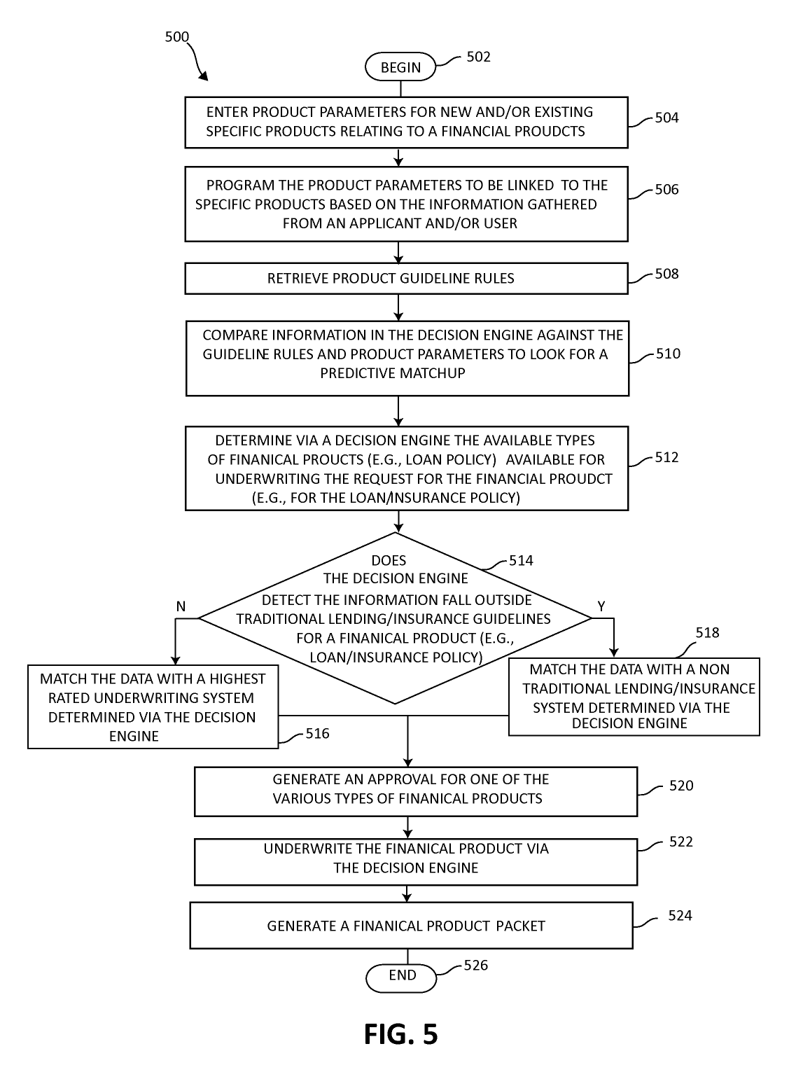

Turning now to FIG. 5, a flowchart illustrating an additional exemplary method 500 for increased efficiency for underwriting using product parameters in the decision engine is depicted. The method 500 begins (step 502) by an administrator, user, a lender, loan officer, insurance agent, and the like upon find/learning a new product and/or for an existing product, entering the product parameters for new and/or existing specific financial product relating to one of the available types of financial products (e.g., loans and/or insurance) (step 504). The product parameters are programmed to be linked to specific financial products based on the information gathered from an applicant or user (step 506). The product guidelines are retrieved (step 508). The method 500 may compare information in the decision engine against the guideline rules and financial product parameters to look for a predictive matchup (step 510). The method 500 may determine via a decision engine the available types of financial products (e.g., loans/insurance policies) available for underwriting the request for the financial products (e.g., loan and/or insurance policy) (step 512). The decision engine then determines and/or detects if the information provided by the applicant falls outside traditional financial product (e.g., lending/insurance) guidelines for a financial product (e.g., provided information disqualifies the applicant from traditional loans/insurance policies) (step 514). For example, the applicant may be applying for a Federal Housing Administration (FHA) mortgage loan but based upon the information gathered from the applicant, the applicant is disqualified under the guidelines and standard for the FHA loan. In this scenario, the applicant may qualify for a sub-prime loan or a hard-money loan. If decision engine determines and/or detects the information provided by the applicant does not fall outside traditional lending/insurance guidelines for a financial products (e.g., a loan and/or insurance policy) the method 500 matches the data with a highest rated underwriting system determined via the decision engine (step 516). If the decision engine determines and/or detects the information provided by the applicant does fall outside traditional financial products (e.g., lending/insurance) guidelines for a financial products (e.g., loan and/or insurance policy), the method 500 matches the data with a non-traditional lending/insurance underwriting system (e.g., sub-prime lenders, hard money lenders) determined via the decision engine (step 516). It should be noted that “traditional” and “non-traditional” loans may vary according to various financial and insurance institutions. These may be defined by a financial and/or insurance institution and used accordingly within the present invention. In a general sense a Non-Traditional loan/policy may be defined as a loan/policy that does not take a traditional form. For example, a traditional loan may require the buyer to pay the principal and interest by following a payment schedule with a down payment (e.g., require a relatively high initial down payment of about 25% and 30-year payment schedule with an interest rate that is compounded on a monthly basis. However, depending upon the financial/insurance institutions, a traditional loan may be viewed as a non-traditional loan based upon the industry and institution's standards, guidelines, policies, and definitions. Non-Traditional mortgages may include interest-only mortgages, payment option adjustable rate mortgages (ARMs) and subprime mortgages. These financial/insurance institutions developed their standards, guidelines, policies, and definitions as a guidance to address risks associated with the growing use of loan and insurance products that, for example, allow borrowers to defer payment of principal and, sometimes, interest. These products, referred to variously as “non-Traditional,” “alternative,” or “exotic” loans and may include “interest-only” loans and “payment option” adjustable-rate loans. For example, these products allow borrowers to exchange lower payments during an initial period for higher payments during a later amortization period. Traditional and non-traditional may also be viewed at the institutional level. For example, a traditional loan/insurance policy may be a loan/insurance policy provided by a financial institution, bank, and the like while a non-traditional loan/insurance policy may be provide by a group of lenders (e.g., hard money loans from private investors), private individuals, and the like.

From both steps 516 and 518, upon completing the matching, the method 500 may generate an approval for one of the various types of financial products (e.g., loans/insurance policies) (step 520). At this point, the financial institutions and/or underwriting systems are bypassed and the need to forward the approval decision to the underwriting systems and financial institutions is eliminated. The method 500 then underwrites the financial product (e.g., loan/insurance policy) via the decision engine (step 522). The method 500 generates a loan/insurance policy packet (step 524). The method 500 ends (step 526).

As mentioned above, these program parameters may assist in providing the financial institutions, banks, underwriters, and the like with applications void of any fraud, errors, and trust thereby providing to the financial institutions, banks, underwriters, and the like a standardized underwriting application suitable for their purposes.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the above figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While one or more embodiments of the present invention have been illustrated in detail, one of ordinary skill in the art will appreciate that modifications and adaptations to those embodiments may be made without departing from the scope of the present invention as set forth in the following claims.

1. A method for increased efficiency for underwriting by a processor device in a computing environment, the method comprising:
processing collected data obtained from a plurality of dynamic sections in a web portal thereby instantaneously underwriting at least one of an available plurality of financial products via a decision engine without necessitating the forwarding of the collected data to an external underwriting system;
determining whether the collected data falls outside one of traditional lending guidelines and insurance guidelines;
matching the collected data with a highest rated underwriting system if the collected data does not fall outside one of the traditional lending guidelines and the insurance policy guidelines; and
matching the collected data with a non-traditional lending system if the collected data does fall outside one of the traditional lending guidelines and the insurance policy guidelines.

2. The method of claim 1, further including, in conjunction with the underwriting, generating a decision for an approval for at least one of the plurality of financial products via the decision engine.

3. The method of claim 2, wherein the underwriting is based upon the availability of the at least one of the plurality of financial products and a closest matching one of the at least one of plurality of financial products with the collected data.

4. The method of claim 1, further including, in response to a user inputting data into each of the plurality of dynamic sections, determining via an alternative decision engine if additional information is required for each of the plurality of dynamic sections, wherein an nth iterations of questions is presented to the user for satisfying at least one of the plurality of dynamic sections based upon answers provided by the user.

5. The method of claim 1, further including, upon completion of the underwriting, generating a packet containing a plurality of documents associated with and required for the underwriting, wherein at least a plurality of terms and conditions and a plurality of governmental required documents are included with the packet.

6. The method of claim 5, further including, upon generating the packet, providing the user via the web portal information explaining data contained in the packet and educational material for understanding the underwriting, the plurality of terms and conditions, and the plurality of governmental required documents contained in the packet.

7. The method of claim 2, further including bypassing, by the decision engine, an existing underwriting mechanism of an external financial services provider, wherein the decision is forwarded to the external financial services provider.

8. The method of claim 7, wherein the decision is structured so as to eliminate a necessity of the financial services provider to implement at least a portion of the existing underwriting mechanism of the external financial services provider against the collected data.

9. The method of claim 1, further including performing each one of:
using a plurality of program parameters for an existing or a new one of the available plurality of financial products, wherein each one of the plurality of program parameters are linked to each one of the existing or the new one of the available plurality of financial products, and
comparing the plurality of program parameters and product guideline rules in the decision with the collected data.

10. A system increased efficiency for underwriting in a computing environment, the system comprising:
a processor device, and
a decision engine, operable by the processor device, wherein the processor device:
processes collected data obtained from a plurality of dynamic sections in a web portal thereby instantaneously underwriting at least one of an available plurality of financial products via the decision engine without necessitating the forwarding of the collected data to an external underwriting system,
determines whether the collected data falls outside one of traditional lending guidelines and insurance guidelines,
matches the collected data with a highest rated underwriting system if the collected data does not fall outside one of the traditional lending guidelines and the insurance policy guidelines, and
matches the collected data with a non-traditional lending system if the collected data does fall outside one of the traditional lending guidelines and the insurance policy guidelines.

11. The system of claim 10, wherein the processor device, in conjunction with the underwriting, generates a decision for an approval for at least one of the plurality of financial products via the decision engine.

12. The system of claim 11, wherein the underwriting is based upon the availability of the at least one of the plurality of financial products and a closest matching one of the at least one of plurality of financial products with the collected data.

13. The system of claim 10, wherein the processor device, in response to a user inputting data into each of the plurality of dynamic sections, determines via an alternative decision engine if additional information is required for each of the plurality of dynamic sections, wherein an nth iterations of questions is presented to the user for satisfying at least one of the plurality of dynamic sections based upon answers provided by the user.

14. The system of claim 10, wherein the processor device, upon completion of the underwriting, generates a packet containing a plurality of documents associated with and required for the underwriting, wherein at least a plurality of terms and conditions and a plurality of governmental required documents are included with the packet.

15. The system of claim 14, wherein the processor device, upon generating the packet, provides the user via the web portal information explaining data contained in the packet and educational material for understanding the underwriting, the plurality of terms and conditions, and the plurality of governmental required documents contained in the packet.

16. The system of claim 11, wherein the decision engine bypasses an existing underwriting mechanism of an external financial services provider, wherein the decision is forwarded to the external financial services provider.

17. The system of claim 16, wherein the decision is structured so as to eliminate a necessity of the financial services provider to implement at least a portion of the existing underwriting mechanism of the external financial services provider against the collected data.

18. The system of claim 10, wherein the processor device performs each one of:
using a plurality of program parameters for an existing or a new one of the available plurality of financial products, wherein each one of the plurality of program parameters are linked to each one of the existing or the new one of the available plurality of financial products, and
comparing the plurality of program parameters and product guideline rules in the decision with the collected data.

19. A computer program product increased efficiency for underwriting in a computing environment by a processor device, the computer program product comprising a non-transitory computer-readable storage medium having computer-readable program code portions stored therein, the computer-readable program code portions comprising:
a first executable portion that processes collected data obtained from a plurality of dynamic sections in a web portal thereby instantaneously underwriting at least one of an available plurality of financial products via a decision engine without necessitating the forwarding of the collected data to an external underwriting system;
a second executable portion that determines whether the collected data falls outside one of traditional lending guidelines and insurance guidelines;
a third executable portion that matches the collected data with a highest rated underwriting system if the collected data does not fall outside one of the traditional lending guidelines and the insurance policy guidelines; and
a fourth executable portion that matches the collected data with a non-traditional lending system if the collected data does fall outside one of the traditional lending guidelines and the insurance policy guidelines.

20. The computer program product of claim 19, further including a fifth executable portion that, in conjunction with the underwriting, generates a decision for an approval for at least one of the plurality of financial products via the decision engine.

21. The computer program product of claim 20, wherein the underwriting is based upon the availability of the at least one of the plurality of financial products and a closest matching one of the at least one of plurality of financial products with the collected data.

22. The computer program product of claim 19, further including a fifth executable portion that, in response to a user inputting data into each of the plurality of dynamic sections, determines via an alternative decision engine if additional information is required for each of the plurality of dynamic sections, wherein an nth iterations of questions is presented to the user for satisfying at least one of the plurality of dynamic sections based upon answers provided by the user.

23. The computer program product of claim 19, further including a fifth executable portion that, upon completion of the underwriting, generates a packet containing a plurality of documents associated with and required for the underwriting, wherein at least a plurality of terms and conditions and a plurality of governmental required documents are included with the packet.

24. The computer program product of claim 23, further including a sixth executable portion that, upon generating the packet, provides the user via the web portal information explaining data contained in the packet and educational material for understanding the underwriting, the plurality of terms and conditions, and the plurality of governmental required documents contained in the packet.

25. The computer program product of claim 20, wherein the decision engine bypasses an existing underwriting mechanism of an external financial services provider, wherein the decision is forwarded to the external financial services provider.

26. The computer program product of claim 19, wherein the decision is structured so as to eliminate a necessity of the financial services provider to implement at least a portion of the existing underwriting mechanism of the external financial services provider against the collected data.

27. The computer program product of claim 19, further including a fifth executable portion that performs each one of:
using a plurality of program parameters for an existing or a new one of the available plurality of financial products, wherein each one of the plurality of program parameters are linked to each one of the existing or the new one of the available plurality of financial products, and
comparing the plurality of program parameters and product guideline rules in the decision with the collected data.
